(19) United States
(12) Patent Application Publication
(10) Pub. No.: US 2020/0058939 A1
(43) Pub. Date: Feb. 20, 2020

(54) POSITIVE ELECTRODE ACTIVE SUBSTANCE, POSITIVE ELECTRODE, BATTERY, BATTERY PACK, ELECTRONIC DEVICE, ELECTRIC VEHICLE, ELECTRIC POWER STORAGE DEVICE, AND ELECTRIC POWER SYSTEM

(71) Applicant: MURATA MANUFACTURING CO., LTD., Kyoto (JP)

(72) Inventors: Yosuke MURAKAMI, Kyoto (JP); Takeshi MIYAZAKI, Kyoto (JP)

(21) Appl. No.: 16/665,263

(22) Filed: Oct. 28, 2019

Related U.S. Application Data
(63) Continuation of application No. PCT/JP2018/016294, filed on Apr. 20, 2018.

(30) Foreign Application Priority Data
Apr. 27, 2017 (JP) 2017-088391

(51) Int. Cl. H01M 4/525; H01M 4/505; H01M 10/42; H01M 10/0525

(52) U.S. Cl. CPC H01M 4/525; H01M 4/505; H01M 2004/027; H01M 10/0525; H01M 10/425

(57) ABSTRACT

A battery includes a positive electrode, a negative electrode, and an electrolyte, wherein the positive electrode includes a plurality of positive electrode active substance grains, and an average number of grain boundaries per one of the positive electrode active substance grains is less than 0.58.

### CROSS REFERENCE TO RELATED APPLICATIONS

The present application is a continuation of PCT patent application no. PCT/JP2018/016294, filed on Apr. 20, 2018, which claims priority to Japanese patent application no. JP2017-088391 filed on Apr. 27, 2017, the entire contents of which are incorporated herein by reference.

### BACKGROUND

The present technology generally relates to a positive electrode active substance, a positive electrode, a battery, a battery pack, an electronic device, an electric vehicle, an electric power storage device, and an electric power system.

As a positive electrode active substance of a lithium ion secondary battery, a LiCoO₂-based active substance (including a composition in which part of Co is substituted with another metal element) is used. A technique is offered in which, in LiCoO₂-based active substances, the occurrence of cracks in the positive electrode active substance grains accompanying the charging and discharging of the battery is reduced by controlling the average crystal grain size within a specified range, thereby improving the cycle characteristics.

### SUMMARY

The present technology generally relates to a positive electrode active substance, a positive electrode, a battery, a battery pack, an electronic device, an electric vehicle, an electric power storage device, and an electric power system.

When the average crystal grain size is controlled, the occurrence of cracks in the positive electrode active substance grains may not be suppressed in a case where there is a plurality of crystallites in the positive electrode active substance grains. In particular, when charging/discharging is performed at a high potential exceeding 4.2 V, it is difficult to suppress the occurrence of cracks. For this reason, there is a possibility that good cycle characteristics may not be obtained even when the average crystal grain size is controlled.

An object of the present technology is to provide a positive electrode active substance, a positive electrode, a battery, a battery pack including the battery, an electronic device, an electric vehicle, an electric power storage device, and an electric power system in which good cycle characteristics can be obtained.

According to an embodiment of the present technology, a battery is provided. The battery includes a positive electrode, a negative electrode, and an electrolyte, wherein the positive electrode includes a plurality of positive electrode active substance grains, and an average number of grain boundaries per one of the positive electrode active substance grains is less than 0.58.

According to an embodiment of the present technology, a positive electrode active substance is provided. The positive electrode active substance includes a plurality of positive electrode active substance grains, wherein an average number of grain boundaries per one of the positive electrode active substance grains is less than 0.58.

According to an embodiment of the present technology, a positive electrode is provided. The positive electrode includes a plurality of positive electrode active substance grains, wherein an average number of grain boundaries per one of the positive electrode active substance grains is less than 0.58.

A battery pack, an electronic device, an electric vehicle, an electric power storage device, and an electric power system of the present technology include the battery as described herein.

According to the present technology, good cycle characteristics can be obtained. It should be understood that the effects described herein are not necessarily limited, and other suitable properties relating to the present technology may be realized and as further described.

### BRIEF DESCRIPTION OF FIGURES

FIG. 1A, FIG. 1B, FIG. 1C, and FIG. 1D are schematic diagrams showing SIM image observation conditions according to an embodiment of the present technology.

FIG. 2A is a schematic diagram for explaining a method of determining a grain boundary, FIG. 2B is a diagram showing a first example of a boundary histogram, and FIG. 2C is a diagram showing a second example of a boundary histogram according to an embodiment of the present technology.

FIG. 3 is a cross-sectional view showing an example of a configuration of a nonaqueous electrolyte secondary battery according to an embodiment of the present technology.

FIG. 4 is an enlarged cross-sectional view showing part of a wound type electrode body shown in FIG. 3.

FIG. 5 is an exploded perspective view showing an example of a configuration of a nonaqueous electrolyte secondary battery according to an embodiment of the present technology.

FIG. 6 is a cross-sectional view taken along line VI-VI in FIG. 5.

FIG. 7 is a block diagram illustrating an example of a configuration of an electronic device as an application example according to an embodiment of the present technology.

FIG. 8 is a schematic diagram showing an example of a configuration of a power storage system in a vehicle as an application example according to an embodiment of the present technology.

FIG. 9 is a schematic diagram showing an example of a configuration of a power storage system in a house as an application example according to an embodiment of the present technology.

FIG. 10 is a graph showing the relationship between the average number of grain boundaries per positive electrode active substance grain and cycle characteristics according to an embodiment of the present technology.

FIG. 11A is a SIM image of a cross section of LiCoO₂ grains whose average number of grain boundaries per LiCoO₂ grain is 0.23, and FIG. 11B is a SIM image of a cross section of LiCoO₂ grains whose average number of grain boundaries per LiCoO₂ grain is 2.25 according to an embodiment of the present technology.

FIG. 12 is a TEM image of a cross section of NCA-based positive electrode active substance grains according to an embodiment of the present technology.

### DETAILED DESCRIPTION

The present technology generally relates to a positive electrode active substance, a positive electrode, a battery, a battery pack, an electronic device, an electric vehicle, an electric power storage device, and an electric power system.

The positive electrode active substance according to the first embodiment of the present technology is a so-called positive electrode active substance for a nonaqueous electrolyte secondary battery, and includes a powder of positive electrode active substance grains. The positive electrode active substance grains can occlude and release lithium, which is an electrode reactant, and include a lithium transition metal composite oxide having a layered rock salt type structure. The positive electrode active substance according to the first embodiment is preferably applied to a nonaqueous electrolyte secondary battery having a high charge voltage (for example, a nonaqueous electrolyte secondary battery having a positive electrode potential exceeding 4.20 V (vsLi/Li⁺) in a fully charged state).

The lithium transition metal composite oxide includes at least one of a lithium cobalt oxide and a composite obtained by substituting part of cobalt of lithium cobalt oxide with another metal element. In this case, the content of another metal element in the lithium transition metal composite oxide is lower than the content of cobalt, for example. The another metal element is at least one selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W).

The lithium transition metal composite oxide preferably has an average composition represented by Equation (1).

LiᵣCo₍₁₋ₛ₎MₛO₍₂₋ₜ₎Fᵤ (1)

where in Equation (1), M represents at least one selected from the group consisting of nickel, manganese, magnesium, aluminum, boron, titanium, vanadium, chromium, iron, copper, zinc, molybdenum, tin, calcium, strontium, tungsten, and combinations thereof, and preferably, represents at least one of aluminum, magnesium, titanium, and combinations thereof. r, s, t, and u are values within the range of 0.8≤r≤1.2, 0≤s≤0.5, −0.1≤t≤0.2, and 0≤u≤0.1. Note that the composition of lithium differs depending on the state of charge and discharge, and the value of r represents the value in the completely discharged state.

The average number of grain boundaries per positive electrode active substance grain is less than 0.58, preferably 0.5 or less, more preferably 0.45 or less, still more preferably 0.31 or less, and particularly preferably 0.23 or less. When the average number of grain boundaries is less than 0.58, cracks of the positive electrode active substance grains due to charge/discharge can be suppressed, and good cycle characteristics can be obtained.

When the positive electrode active substance grains have a grain boundary, at the time of charge and discharge, each crystallite expands and contracts in different directions with the grain boundary as a boundary. For this reason, cracks are likely to occur at the positions of the grain boundaries during charge and discharge. Therefore, in order to obtain good cycle characteristics, it is preferable to define the average number of grain boundaries per positive electrode active substance grain as described above. In lithium transition metal composite oxides having a layered rock salt type structure, it is easy to cause breakage of the grain boundary due to changes in the layered rock salt structure during high-potential charge/discharge, so that it is particularly preferable to define the average number of grain boundaries as described above.

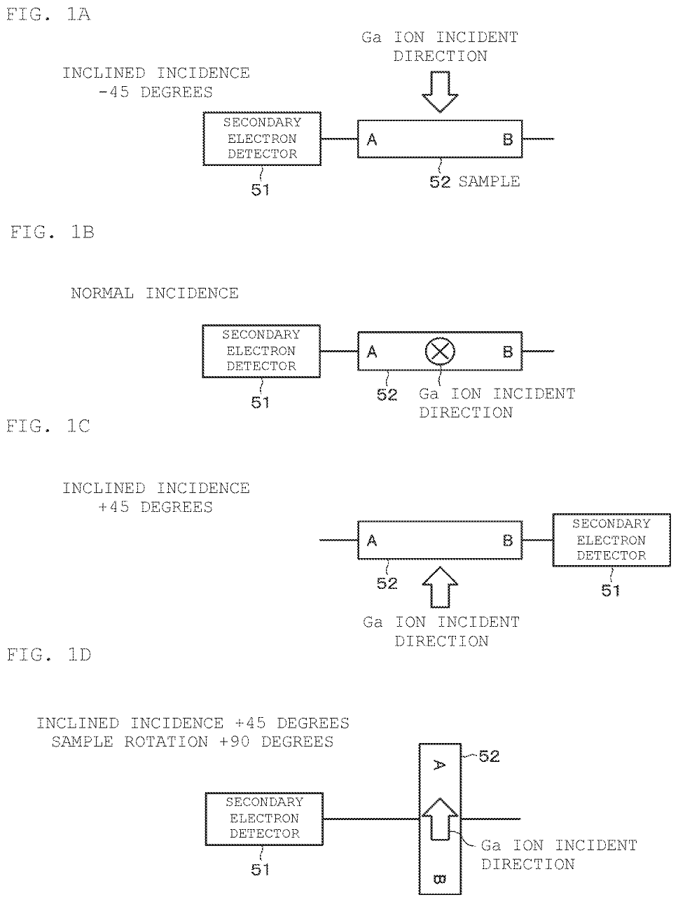

The average number of grain boundaries per positive electrode active substance grain is calculated as follows. First, after the positive electrode active substance is hardened with a resin and the cross section of the positive electrode active substance grains is cut out, the cross section is polished by ion milling. Next, a SIM image of a cross section of the positive electrode active substance grains is taken using a focused ion beam (FIB) (HELIOS NANOLAB 400S; acceleration voltage 5 kV) manufactured by FEI. In particular, in order to make it easier to discriminate processing irregularities other than grain boundaries (the so-called focused ion beam (FIB) processing curtaining effect) and the contrast of the side walls of the grains, by changing the orientation relationship between the incident direction of Ga ions, a sample 51 and a secondary electron detector 52, SIM images of the same field of view (about 40 μm×80 μm) are captured with respect to four orientations as shown in FIGS. 1A to 1D. In FIGS. 1A to 1D, letters “A” and “B” are attached to both ends of the sample 51 in order to clarify the direction of the sample 51. Subsequently, the number of grains and the number of grain boundaries in the captured SIM image are measured, and the average number of grain boundaries per positive electrode active substance grain (number of grain boundaries in the SIM image/number of grains in the SIM image) is calculated. In the calculation, the positive electrode active substance grains whose long axis length is 500 nm or less are not counted as grains. Here, the long axis length means the maximum distance (so-called maximum ferret diameter) among the distances between two parallel lines drawn from all angles so as to be tangent to the contour of the grain. In the present embodiment, the number of grain boundaries is measured using the SIM image because the SIM image shows a stronger crystal orientation contrast than an SEM image or the like.

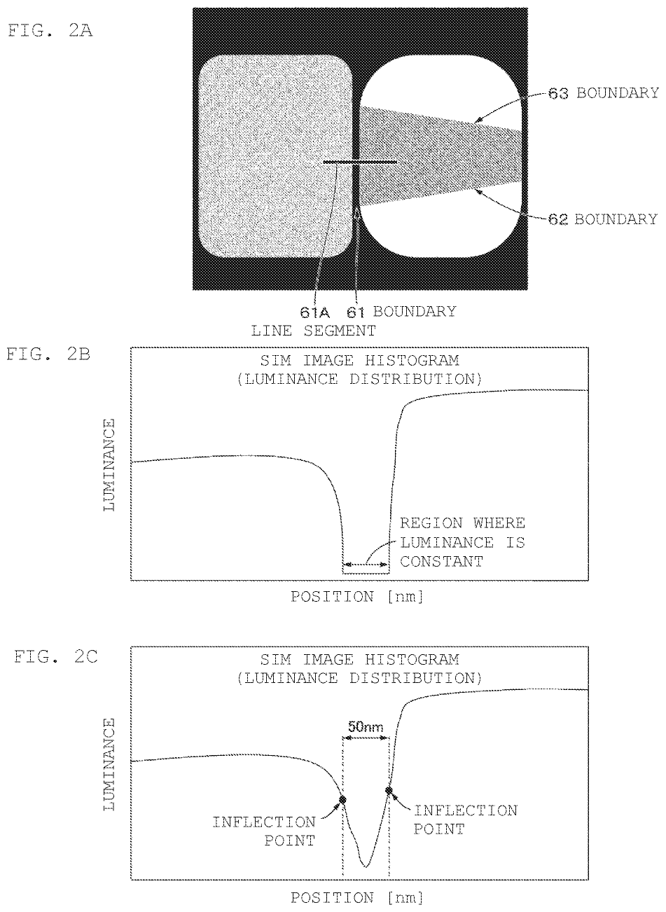

In the SIM image, the contrast (crystal orientation contrast) changes with the grain boundary as a boundary. On the other hand, the gap between grains appears dark. For this reason, in the above “calculation method of the average number of grain boundaries per positive electrode active substance grain”, whether the boundary where the contrast changes in the captured SIM image is “grain boundary (boundary when the crystal orientation is different)” or “gap between grains (gap between positive electrode active substance grains)” is determined as described below. Here, an example of determining whether a boundary 61 shown in FIG. 2A is a “grain boundary” or a “gap between grains” will be described. It is assumed that FIG. 2A shows one captured SIM image.

First, from the captured SIM image, as shown in FIG. 2A, a histogram (a histogram indicating luminance distribution) in a direction substantially perpendicular to the extending direction of the boundary 61 of interest (specifically, the extending direction of a line segment 61A shown in FIG. 2A) is acquired. Next, it is determined whether there is a region where the luminance decreases and is constant in a portion corresponding to the boundary 61 in the acquired histogram. As shown in FIG. 2B, when there is a region where the luminance decreases and is constant, the boundary 61 is determined to be a “gap between grains”. On the other hand, as shown in FIG. 2C, when there is no region where the luminance decreases and is constant (i.e., when the histogram changes in a V shape), after obtaining the inflection points of the two respective curves that incline rapidly toward the center of the boundary, the distance between these inflection points in the horizontal axis direction is obtained. When there are three or more inflection points although the histogram changes in a substantially V shape, the inflection point is obtained by a curve (so-called Gaussian fitting) approximated by a normal distribution. Then, it is determined whether this distance is 50 nm or more. When the distance between the inflection points in the horizontal axis direction is 50 nm or more, the boundary 61 is determined to be a “gap between grains”. On the other hand, when the distance direction between the inflection points in the horizontal axis is less than 50 nm, the boundary 61 is determined to be a “grain boundary”.

For example, when among the boundaries 61 to 63 in FIG. 2A (SIM image), the boundary 61 is determined to be a “gap between grains”, and the boundaries 62 and 63 are determined to be “grain boundaries”, there are two grains in the SIM image, and there are two grain boundaries. Therefore, the average number of grain boundaries per positive electrode active substance grain (the number of grain boundaries in the SIM image/the number of grains in the SIM image) is “1”.

The average grain diameter of the positive electrode active substance grains is preferably 2 μm or more and 50 μm or less, more preferably 5 μm or more and 40 μm or less. In a case where the average grain diameter is less than 2 μm, when making the positive electrode, since the positive electrode active substance easily falls off from the positive electrode current collector in the pressing process, and in addition, the surface area of the positive electrode active substance is increased, the amount of addition of a conductive agent or a binder have to be to be increased, and the energy density per unit mass is small. On the other hand, when the average grain diameter exceeds 50 μm, the possibility that the positive electrode active substance penetrates the separator to cause a short circuit is increased.

The average grain diameter of the positive electrode active substance grains may be an average of grain sizes measured by a so-called grain size distribution meter. It is also possible to obtain the average grain diameter from the grains in the SIM image in the above “Calculation method of average number of grain boundaries per positive electrode active substance grain”. In this case, 10 grains are randomly selected from the captured SIM image, the cross-sectional area of the grain by image processing is measured, and the grain size (diameter) of each grain is determined assuming that the grain cross-section is circular. Subsequently, the average grain size is obtained by simply averaging (arithmetic average) the grain sizes of the ten measured grains, and is used as the average grain diameter of the positive electrode active substance grains.

Hereinafter, an example of a method of producing a positive electrode active substance having the above-described configuration will be described. First, cobalt oxide (Co₃O₄) is produced by roasting from cobalt hydroxide as a raw material. At this time, it is preferable to suppress generation of grain boundaries of cobalt oxide. This is because the number of grain boundaries of cobalt oxide (Co₃O₄) affects the number of grain boundaries of the positive electrode active substance to be finally obtained. When cobalt oxide (Co₃O₄) is produced by roasting, the production temperature is preferably 850° C. or lower, more preferably 800° C. or lower. This is because Co₃O₄ may undergo a phase transition to CoO at a temperature of about 900° C., and this phase transition may induce the grain boundary.

Next, after mixing cobalt oxide (Co₃O₄), lithium carbonate (Li₂CO₃), and a compound containing an additive element as necessary, the resulting mixture is fired, whereby a LiCoO₂-based active substance (including a composition in which part of Co is substituted with another metal element) is obtained. At this time, the firing temperature is preferably 850° C. or lower, more preferably 800° C. or lower. This is because Co₃O₄ may undergo phase transition to CoO at a temperature of about 900° C. as described above. Thereafter, it is preferable to perform particle sizing without pulverization. This is because, when the LiCoO₂-based active substance is pulverized, defects are generated, and grain boundaries may be formed in the process of recovering the defects by heat treatment after pulverization. As a result, the intended positive electrode active substance is obtained.

Since the positive electrode active substance according to the first embodiment includes a powder of positive electrode active substance grains, and the average number of grain boundaries per positive electrode active substance grain is less than 0.58, it is possible to suppress the crack of the positive electrode active substance grains due to charge/discharge. Therefore, a battery having good cycle characteristics can be produced.

In the second embodiment, a nonaqueous electrolyte secondary battery including a positive electrode including the positive electrode active substance according to the first embodiment will be described.

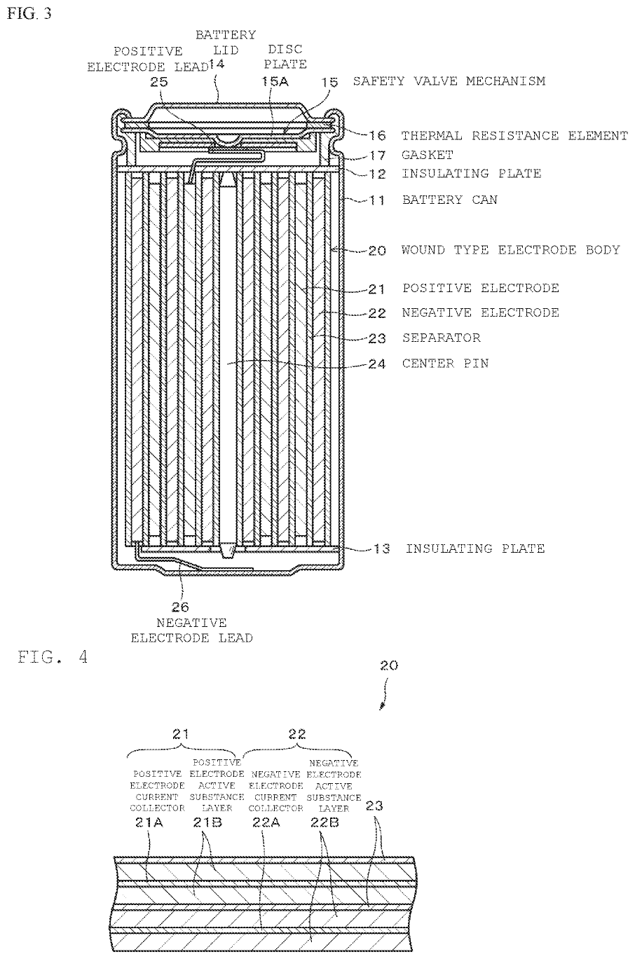

Hereinafter, a configuration example of a nonaqueous electrolyte secondary battery (hereinafter simply referred to as a “battery”) according to the second embodiment of the present technology will be described with reference to FIG. 3. This battery is a so-called lithium ion secondary battery, for example, in which the capacitance of the negative electrode is represented by a capacitance component due to occlusion and release of lithium (Li) as an electrode reactant. This battery is a so-called cylindrical type, and includes a wound type electrode body 20 in which a pair of a strip-like positive electrode 21 and a strip-like negative electrode 22 are laminated and wound with a separator 23 interposed there between inside a substantially hollow cylindrical battery can 11. The battery can 11 is made of iron (Fe) plated with nickel (Ni), and its one end is closed and the other end is opened. Inside the battery can 11, an electrolytic solution as a liquid electrolyte is injected and with which the positive electrode 21, the negative electrode 22, and the separator 23 are impregnated. In addition, a pair of insulating plates 12 and 13 is arranged perpendicular to the wound peripheral face so as to sandwich the wound type electrode body 20.

At the open end of the battery can 11, a battery lid 14, and a safety valve mechanism 15 and a thermal resistance element (positive temperature coefficient; PTC element) 16 provided inside the battery lid 14 are crimped and attached with a sealing gasket 17 interposed therebetween. Thereby, the inside of the battery can 11 is sealed. The battery lid 14 includes, for example, the same material as the battery can 11. The safety valve mechanism 15 is electrically connected to the battery lid 14, and when the internal pressure of the battery exceeds a certain level due to an internal short circuit or external heating, a disc plate 15A is inverted, so that the electrical connection between the battery lid 14 and the wound type electrode body 20 is cut. The sealing gasket 17 is made of, for example, an insulating material, and asphalt is applied to its surface.

For example, a center pin 24 is inserted in the center of the wound type electrode body 20. A positive electrode lead 25 made of aluminum (Al) or the like is connected to the positive electrode 21 of the wound type electrode body 20, and a negative electrode lead 26 made of nickel or the like is connected to the negative electrode 22. The positive electrode lead 25 is electrically connected to the battery lid 14 by being welded to the safety valve mechanism 15, and the negative electrode lead 26 is welded and electrically connected to the battery can 11.

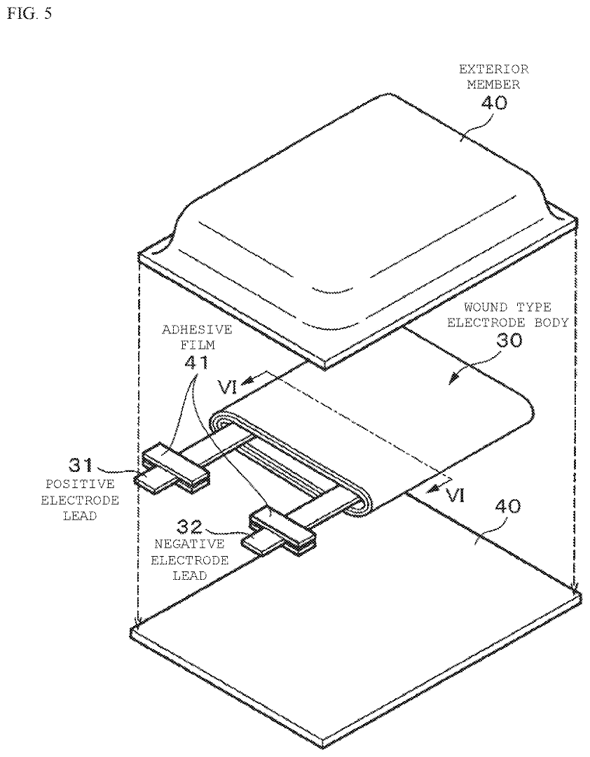

Hereinafter, the positive electrode 21, the negative electrode 22, the separator 23, and the electrolytic solution constituting the battery will be sequentially described with reference to FIG. 4.

The positive electrode 21 has, for example, a structure in which positive electrode active substance layers 21B are provided on both surfaces of a positive electrode current collector 21A. Although not shown, the positive electrode active substance layer 21B may be provided only on one surface of the positive electrode current collector 21A. The positive electrode current collector 21A includes, for example, a metal foil such as an aluminum foil, a nickel foil, or a stainless steel foil. The positive electrode active substance layer 21B contains a positive electrode active substance. The positive electrode active substance layer 21B may further include at least one of a conductive agent and a binder as necessary.

The positive electrode active substance is a positive electrode active substance according to the first embodiment.

As a binder, for example, at least one selected from resin materials such as polyvinylidene fluoride (PVdF), polytetrafluoroethylene (PTFE), polyacrylonitrile (PAN), styrene butadiene rubber (SBR) and carboxymethyl cellulose (CMC), and co-polymers mainly composed of these resin materials is used.

Examples of the conductive agent include carbon materials such as graphite, carbon fiber, carbon black, ketjen black or carbon nanotube, and one of these may be used alone, or two or more of them may be mixed and used.

In addition to the carbon material, a metal material or a conductive polymer material may be used as long as the material has conductivity.

The negative electrode 22 has, for example, a structure in which negative electrode active substance layers 22B are provided on both surfaces of a negative electrode current collector 22A. Although not shown, the negative electrode active substance layer 22B may be provided only on one surface of the negative electrode current collector 22A. The negative electrode current collector 22A is made of, for example, a metal foil such as a copper foil, a nickel foil, or a stainless steel foil.

The negative electrode active substance layer 22B contains one or more negative electrode active substances capable of occluding and releasing lithium. The negative electrode active substance layer 22B may further include at least one of a binder and a conductive agent as necessary.

In this battery, the electrochemical equivalent of the negative electrode 22 or the negative electrode active substance is larger than the electrochemical equivalent of the positive electrode 21, and theoretically, lithium metal preferably does not precipitate on the negative electrode 22 during charging.

Examples of the negative electrode active substance include carbon materials such as non-graphitizable carbon, graphitizable carbon, graphite, pyrolytic carbons, cokes, glassy carbons, organic polymer compound fired bodies, carbon fibers, and activated carbon. Among these, examples of cokes include pitch coke, needle coke, and petroleum coke. The organic polymer compound fired body refers to carbonized materials obtained by firing a polymer material such as phenol resin or furan resin at an appropriate temperature, and some are classified as non-graphitizable carbon or graphitizable carbon. These carbon materials are preferable because they have very little change in the crystal structure generated during charge and discharge, high charge and discharge capacitance can be obtained, and good cycle characteristics can be obtained. In particular, graphite is preferable because it has a high electrochemical equivalent and can provide a high energy density. Further, non-graphitizable carbon is preferable because it can have excellent cycle characteristics. Furthermore, materials having a low charge/discharge potential, specifically materials having a charge/discharge potential close to that of the lithium metal is preferable because high energy density of the battery can be easily realized.

Another example of the negative electrode active substance capable of increasing the capacitance is a material containing at least one of a metal element and a metalloid element as a constituent element (for example, an alloy, a compound, or a mixture). With such a material, high energy density can be obtained. In particular, when used together with a carbon material, a high energy density can be obtained, and excellent cycle characteristics can be obtained, which is more preferable. In the present technology, alloys include a material containing two or more metal elements, and a material containing one or more metal elements and one or more metalloid elements. Moreover, they may contain a nonmetallic element. The structure includes a solid solution, a eutectic (eutectic mixture), an intermetallic compound or a mixture of two or more of them.

Examples of such a negative electrode active substance include a metal element or a metalloid element capable of forming an alloy with lithium. In particular, the examples include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd), and platinum (Pt). These may be crystalline or amorphous.

As the negative electrode active substance, materials containing a 4B group metal element or a metalloid element in the short-period periodic table as a constituent element are preferred, and materials containing at least one of silicon and tin as a constituent element are more preferred. This is because silicon and tin have a large ability to occlude and release lithium, and a high energy density can be obtained. Examples of such a negative electrode active substance include silicon, an alloy of silicon, and a compound of silicon, and tin, an alloy of tin, and a compound of tin, and a material having one or two or more phases thereof as part of the material.

Examples of an alloy of silicon include materials containing at least one selected from the group consisting of tin, nickel, copper, iron, cobalt, manganese, zinc, indium, silver, titanium, germanium, bismuth, antimony (Sb), and chromium as the second constituent element in addition to silicon. Examples of an alloy of tin include materials containing at least one selected from the group consisting of silicon, nickel, copper, iron, cobalt, manganese, zinc, indium, silver, titanium, germanium, bismuth, antimony, and chromium as the second constituent element in addition to tin.

Examples of the tin compound or silicon compound include materials containing oxygen or carbon, and may contain the second constituent element described above in addition to tin or silicon.

Among these, as the Sn-based negative electrode active substance, a SnCoC-containing material that contains cobalt, tin, and carbon as constituent elements, whose carbon content is 9.9 mass % or more and 29.7 mass % or less, and whose ratio of cobalt with respect to the sum of tin and cobalt is 30 mass % or more and 70 mass % or less is preferable. This is because a high energy density can be obtained, and excellent cycle characteristics can be obtained in such a composition range.

This SnCoC-containing material may further contain another constituent element as necessary. Examples of the other constituent element preferably include silicon, iron, nickel, chromium, indium, niobium, germanium, titanium, molybdenum, aluminum, phosphorus (P), gallium and bismuth, and may include two or more of them. This is because the capacitance or cycle characteristics can be further improved.

This SnCoC-containing material has a phase containing tin, cobalt, and carbon, and this phase preferably has a low crystallinity or an amorphous structure. In this SnCoC-containing material, it is preferable that at least part of carbon as a constituent element be bonded to a metal element or a metalloid element which is another constituent element. This is because the decrease in cycle characteristics is thought to be due to the aggregation or crystallization of tin or the like, and such aggregation or crystallization can be suppressed by carbon bonded to another element.

An example of a measuring method of examining the bonding state of elements includes an X-ray photoelectron spectroscopy (XPS). In the XPS, for graphite, the peak of the 1s orbit (C1s) of carbon appears at 284.5 eV in an apparatus calibrated so that the peak of the 4f orbit (Au4f) of atom of gold can be obtained at 84.0 eV. For surface contaminated carbon, it appears at 284.8 eV. On the other hand, when the charge density of the carbon element is high, for example, when carbon is bonded to a metal element or a metalloid element, the peak of the C1s appears in a region lower than 284.5 eV. That is, when the peak of the synthesized wave of the C1s obtained for the SnCoC-containing material appears in a region lower than 284.5 eV, at least part of carbon contained in the SnCoC-containing material is bonded to a metal element or a metalloid element, which is another constituent element.

In the XPS measurement, for example, the peak of the C1 s is used to correct the energy axis of the spectrum. Usually, since the surface contaminated carbon exists on the surface, the peak of the C1s of the surface contaminated carbon is set to 284.8 eV, which is used as an energy reference. In the XPS measurement, since the waveform of the peak of the C1s is obtained as a shape including the peak of the surface contaminated carbon and the peak of carbon in the SnCoC-containing material, the peak of surface contaminated carbon and the peak of carbon in the SnCoC-containing material are separated by performing an analysis using, for example, commercially available software. In the analysis of the waveform, the position of the main peak present on the lowest binding energy side is set to the energy reference (284.8 eV).

Examples of another negative electrode active substance include metal oxides and polymer compounds that can occlude and release lithium. Examples of the metal oxide include lithium titanium oxide containing titanium and lithium, such as lithium titanate (Li₄Ti₅O₁₂), iron oxide, ruthenium oxide, and molybdenum oxide. Examples of the polymer compound include polyacetylene, polyaniline, and polypyrrole.

As a binder, for example, at least one selected from resin materials such as polyvinylidene fluoride, polytetrafluoroethylene, polyacrylonitrile, styrene butadiene rubber and carboxymethyl cellulose, and co-polymers mainly composed of these resin materials is used.

As the conductive agent, the carbon material same as that of the positive electrode active substance layer 21B can be used.

The separator 23 separates the positive electrode 21 and the negative electrode 22 and allows lithium ions to pass through while suppressing a short circuit of current due to contact between both electrodes. The separator 23 is made of, for example, a porous membrane made of a resin such as polytetrafluoroethylene, polypropylene, or polyethylene, and may have a structure in which two or more of the porous membranes are laminated. Among them, a porous membrane made of polyolefin is preferable because it is excellent in the short circuit suppressing effect and can improve the safety of the battery by the shutdown effect. In particular, polyethylene is preferable as a material constituting the separator 23 because a shutdown effect can be obtained within a range of 100° C. or higher and 160° C. or lower and excellent in electrochemical stability. In addition, a material obtained by copolymerizing or blending a resin having chemical stability with polyethylene or polypropylene can be used. Alternatively, the porous membrane may have a structure of three or more layers in which a polypropylene layer, a polyethylene layer, and a polypropylene layer are sequentially laminated.

The separator 23 may have a configuration including a substrate and a surface layer provided on one or both surfaces of the substrate. The surface layer includes inorganic grains having electrical insulating properties and a resin material that binds the inorganic grains to the surface of the substrate and binds the inorganic grains to each other. This resin material may have, for example, a three-dimensional network structure in which the material is fibrillated and the fibrils are continuously connected to each other. The inorganic grains can be maintained in a dispersed state without being connected to each other by being supported on the resin material having the three-dimensional network structure. Further, the surface of the substrate and the inorganic grains may be bound to each other without the resin material being fibrillated. In this case, higher binding properties can be obtained. By providing a surface layer on one surface or both surfaces of the substrate as described above, oxidation resistance, heat resistance and mechanical strength can be imparted to the substrate.

The substrate is a porous layer having porosity. More specifically, the substrate is a porous membrane composed of an insulating film having a large ion permeability and a predetermined mechanical strength, and the electrolytic solution is held in the pores of the substrate. It is preferable that the substrate have a predetermined mechanical strength as a main part of the separator, while having a high resistance, a low reactivity, and a property of being difficult to expand with respect to an electrolytic solution.

As the resin material constituting the substrate, for example, a polyolefin resin such as polypropylene or polyethylene, an acrylic resin, a styrene resin, a polyester resin, or a nylon resin is preferably used. In particular, polyethylene such as low density polyethylene, high density polyethylene, and linear polyethylene, or low molecular weight wax thereof, or polyolefin resin such as polypropylene has an appropriate melting temperature, and is easily available, and thus can be preferably used. Further, a structure obtained by laminating two or more kinds of porous membranes, or a porous membrane formed by melting and kneading two or more kinds of resin materials may be used. A material including a porous membrane made of a polyolefin resin is excellent in the separation between the positive electrode 21 and the negative electrode 22, and can further reduce the decrease in internal short circuit.

A nonwoven fabric may be used as the substrate. As the fibers constituting the nonwoven fabric, aramid fibers, glass fibers, polyolefin fibers, polyethylene terephthalate (PET) fibers, nylon fibers, or the like can be used. Alternatively, these two or more kinds of fibers may be mixed to form a nonwoven fabric.

The inorganic grains include at least one of metal oxide, metal nitride, metal carbide, metal sulfide and the like. As the metal oxide, aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂) or oxide yttrium (yttria, Y₂O₃) or the like can be preferably used. As the metal nitride, silicon nitride (Si₃N₄), aluminum nitride (AlN), boron nitride (BN), titanium nitride (TiN), or the like can be preferably used. As the metal carbide, silicon carbide (SiC), boron carbide (B4C), or the like can be preferably used. As the metal sulfide, barium sulfate (BaSO₄) or the like can be preferably used. Further, porous aluminosilicate such as zeolite (M_{2/n}O.Al₂O₃.xSiO₂.yH₂O, where M is a metal element, and x≥2, y≥0), layered silicate, barium titanate (BaTIO₃) or strontium titanate minerals such as (SrTiO₃) may be used. Among these, it is preferable to use alumina, titania (particularly those having a rutile structure), silica or magnesia, and it is more preferable to use alumina. The inorganic grains have oxidation resistance and heat resistance, and the surface layer facing the positive electrode containing the inorganic grains has strong resistance to an oxidizing environment in the vicinity of the positive electrode during charging. The shape of the inorganic grains is not particularly limited, and any of a spherical shape, a plate shape, a fiber shape, a cubic shape, a random shape, and the like can be used.

Examples of the resin material constituting the surface layer include fluorine-containing resins such as polyvinylidene fluoride and polytetrafluoroethylene, fluorine-containing rubbers such as a vinylidene fluoride-tetrafluoroethylene copolymer and an ethylene-tetrafluoroethylene copolymer, rubbers such as a styrene-butadiene copolymer or a hydride thereof, an acrylonitrile-butadiene copolymer or a hydride thereof, an acrylonitrile-butadiene-styrene copolymer or a hydride thereof, a methacrylic acid ester-acrylic acid ester copolymer, a styrene-acrylic acid ester copolymer, an acrylonitrile-acrylic acid ester copolymer, an ethylene propylene rubber, polyvinyl alcohol, and polyvinyl acetate, cellulose derivatives such as ethylcellulose, methylcellulose, hydroxyethylcellulose, carboxymethylcellulose, polyphenylene ether, polysulfone, polyether sulfone, polyphenylene sulfide, polyether imide, polyimide, polyamide such as wholly aromatic polyamide (aramid), polyamideimide, polyacrylonitrile, polyvinyl alcohol, polyether, and a high heat resistant resin having at least one of a melting point and a glass transition temperature of 180° C. or higher, such as an acrylic acid resin or polyester. These resin materials may be used alone or in combination of two or more. Among them, a fluorine-based resin such as polyvinylidene fluoride is preferable from the viewpoint of oxidation resistance and flexibility, and it is preferable to contain aramid or polyamideimide from the viewpoint of heat resistance.

The grain size of the inorganic grains is preferably in the range of 1 nm to 10 μm. When the size is smaller than 1 nm, it is difficult to obtain the grains, and even if they can be obtained, they are not cost effective. On the other hand, when the size is larger than 10 μm, the distance between the electrodes is large, so that the sufficient filling amount of the active substance cannot be obtained in a limited space, and the battery capacitance is low.

As a method of forming the surface layer may include, for example, applying a slurry composed of a matrix resin, a solvent, and an inorganic material to a substrate (porous membrane), and allowing the coated substrate to pass through a poor solvent of the matrix resin and a bath compatible with the above-described solvent, thereby causing phase separation, and then drying the resulting substrate.

In addition, the inorganic grain mentioned above may be contained in the porous membrane as the substrate. Further, the surface layer may not include inorganic grains and may be made only of a resin material.

The separator 23 is impregnated with an electrolytic solution that is a liquid electrolyte. The electrolytic solution contains a solvent and an electrolyte salt dissolved in the solvent. The electrolytic solution may contain a known additive in order to improve battery characteristics.

As the solvent, cyclic carbonate such as ethylene carbonate or propylene carbonate can be used, and one of ethylene carbonate and propylene carbonate, particularly, a mixture of both is preferably used. This is because the cycle characteristics can be improved.

As the solvent, in addition to the cyclic carbonate, it is preferable to use a mixture of chain carbonate such as diethyl carbonate, dimethyl carbonate, ethyl methyl carbonate or methyl propyl carbonate. This is because high ionic conductivity can be obtained.

The solvent preferably still further contains 2,4-difluoroanisole or vinylene carbonate. This is because 2,4-difluoroanisole can improve discharge capacitance, and vinylene carbonate can improve cycle characteristics. Therefore, it is preferable to use a mixture of these because the discharge capacitance and the cycle characteristics can be improved.

Besides these, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropylonitrile, N, N-dimethylformamide, N-methylpyrrolidinone, N-methyloxazolidinone, N, N-dimethylimidazolidinone, nitromethane, nitroethane, sulfolane, dimethyl sulfoxide, and trimethyl phosphate.

A compound obtained by substituting at least part of hydrogen in the non-aqueous solvent with fluorine may be preferable because the reversibility of the electrode reaction may be improved depending on the type of electrode to be combined.

An example of the electrolyte salt include lithium salt, and one type may be used alone, or two or more types may be mixed and used. Examples of the lithium salt include LiPF₆, LiBF₄, LiAsF₆, LiClO₄, LiB (C₆H₅)₄, LiCH₃SO₃, LiCF₃SO₃, LiN(SO₂CF₃)₂, LiC(SO₂CF₃)₃, LiAlCl₄, LiSiF₆, LiCl, difluoro [oxolato-O,O′] lithium borate, lithium bisoxalate borate, and LiBr. Among them, LiPF₆ is preferable because it is possible to obtain high ionic conductivity and improve cycle characteristics.

The positive electrode potential (vsLi/Li⁺) in the fully charged state is preferably more than 4.20 V, more preferably 4.25 V or more, further more preferably more than 4.40 V, particularly preferably 4.45 V or more, most preferably 4.50 V or more. However, the positive electrode potential (vsLi/Li⁺) in the fully charged state may be 4.20 V or less. Although the upper limit value of the positive electrode potential (vsLi/Li⁺) in the fully charged state is not particularly limited, it is preferably 6.00 V or less, more preferably 5.00 V or less, further more preferably 4.80 V or less, and particularly preferably 4.70 V or less.

In the battery having the above-described configuration, when charged, for example, lithium ions are released from the positive electrode active substance layer 21B and are occluded into the negative electrode active substance layer 22B with the electrolytic solution interposed therebetween. In addition, when discharged, for example, lithium ions are released from the negative electrode active substance layer 22B, and are occluded in the positive electrode active substance layer 21B with the electrolytic solution interposed therebetween.

Next, an example of a method of manufacturing battery according to the second embodiment of the present technology will be described.

First, for example, a positive electrode active substance according to the first embodiment, a conductive agent, and a binder are mixed to prepare a positive electrode mixture, and this positive electrode mixture is dispersed in a solvent such as N-methyl-2-pyrrolidone (NMP) to produce a paste-like positive electrode mixture slurry. Next, the positive electrode mixture slurry is applied to the positive electrode current collector 21A, the solvent is dried, and the positive electrode active substance layer 21B is formed by compression molding using a roll press machine or the like to form the positive electrode 21.

Further, for example, a negative electrode active substance and a binder are mixed to prepare a negative electrode mixture, and this negative electrode mixture is dispersed in a solvent such as N-methyl-2-pyrrolidone to produce a paste-like negative electrode mixture slurry. Next, the negative electrode mixture slurry is applied to the negative electrode current collector 22A, the solvent is dried, and the negative electrode active substance layer 22B is formed by compression molding using a roll press machine or the like to form the negative electrode 22.

Next, the positive electrode lead 25 is attached to the positive electrode current collector 21A by welding or the like, and the negative electrode lead 26 is attached to the negative electrode current collector 22A by welding or the like.

Next, the positive electrode 21 and the negative electrode 22 are wound with the separator 23 interposed therebetween. Next, the distal end of the positive electrode lead 25 is welded to the safety valve mechanism 15, and the distal end of the negative electrode lead 26 is welded to the battery can 11, and the wound positive electrode 21 and negative electrode 22 are sandwiched by a pair of insulating plates 12 and 13, and are housed inside the sandwiched battery can 11. Next, after the positive electrode 21 and the negative electrode 22 are housed in the battery can 11, the electrolytic solution is injected into the battery can 11 and the separator 23 is impregnated with the electrolytic solution. Next, the battery lid 14, the safety valve mechanism 15 and the thermal resistance element 16 are crimped and fixed to the end the opening of the battery can 11 with the sealing gasket 17 interposed therebetween. Thereby, the battery shown in FIG. 3 is obtained.

In the battery according to the second embodiment, since the positive electrode active substance layer 21B includes the positive electrode active substance according to the first embodiment, cracks of the positive electrode active substance grains due to charge/discharge can be suppressed. Therefore, a battery having good cycle characteristics can be produced. In particular, when the positive electrode potential (vsLi/Li⁺) in a fully charged state exceeds 4.40 V, the above effect is remarkably exhibited.

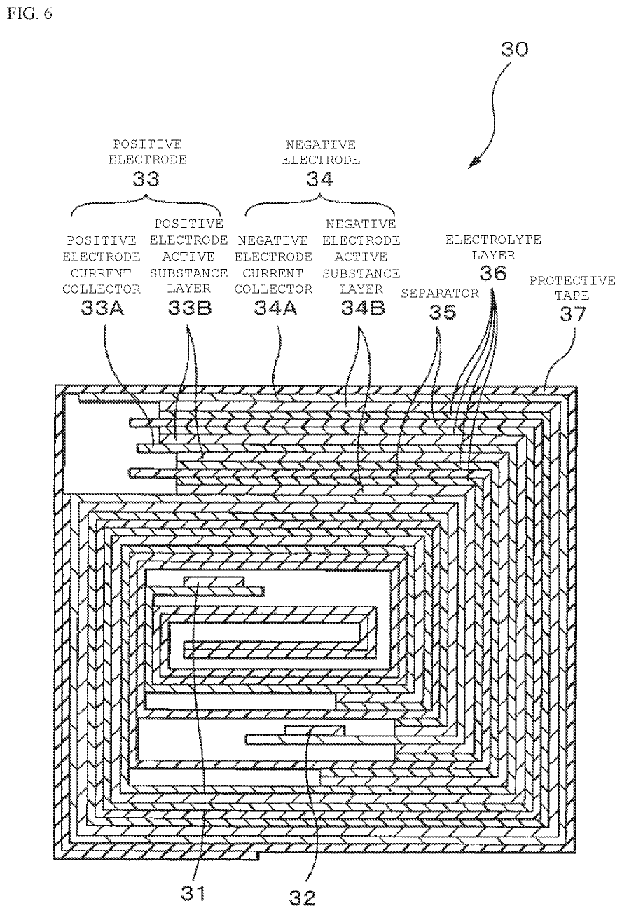

As shown in FIG. 5, the battery according to the third embodiment of the present technology is a so-called laminated film type battery, a wound type electrode body 30 to which a positive electrode lead 31 and a negative electrode lead 32 are attached is housed in a film-like exterior member 40, and it is possible to reduce the size, weight and thickness.

The positive electrode lead 31 and the negative electrode lead 32 are each led out from the inside of the exterior member 40 to the outside, for example, in the same direction. The positive electrode lead 31 and the negative electrode lead 32 are made of, for example, a metal material such as aluminum, copper, nickel, or stainless steel, and each have a thin plate shape or a mesh shape.

The exterior member 40 is made of, for example, a rectangular aluminum laminated film in which a nylon film, an aluminum foil, and a polyethylene film are bonded together in this order. The exterior member 40 is disposed, for example, so that the polyethylene film and the wound type electrode body 30 face each other, and the respective outer edge portions are in close contact with each other by fusion or an adhesive. Adhesive films 41 are inserted between the exterior member 40 and the positive electrode lead 31, and the exterior member 40 and the negative electrode lead 32 to suppress intrusion of outside air. The adhesive film 41 is made of a material having adhesion to the positive electrode lead 31 and the negative electrode lead 32, for example, a polyolefin resin such as polyethylene, polypropylene, modified polyethylene, or modified polypropylene.

It should be understood that the exterior member 40 may be configured by a laminated film having another structure, a polymer film such as polypropylene, or a metal film, instead of the above-described aluminum laminated film. Alternatively, a laminated film in which an aluminum film is used as a core and a polymer film is laminated on one or both surfaces thereof may be used.

FIG. 6 is a cross-sectional view taken along line VI-VI of the wound type electrode body 30 shown in FIG. 5. The wound type electrode body 30 is obtained by laminating a positive electrode 33 and a negative electrode 34 with a separator 35 and an electrolyte layer 36 interposed therebetween and winding them, and the outermost periphery is protected by a protective tape 37.

The positive electrode 33 has a structure in which a positive electrode active substance layer 33B is provided on one surface or both surfaces of a positive electrode current collector 33A. The negative electrode 34 has a structure in which a negative electrode active substance layer 34B is provided on one surface or both surfaces of a negative electrode current collector 34A, and the negative electrode active substance layer 34B and the positive electrode active substance layer 33B are arranged to face each other. The configurations of the positive electrode current collector 33A, the positive electrode active substance layer 33B, the negative electrode current collector 34A, the negative electrode active substance layer 34B, and the separator 35 are the same as those of the positive electrode current collector 21A, the positive electrode active substance layer 21B, the negative electrode current collector 22A, the negative electrode active substance layer 22B, and the separator 23 in the second embodiment, respectively.

The electrolyte layer 36 includes an electrolytic solution and a polymer compound serving as a holding body that holds the electrolytic solution, and is in a so-called gel state. The gelled electrolyte layer 36 is preferable because it can obtain high ionic conductivity and suppress battery leakage. The electrolytic solution is an electrolytic solution according to the second embodiment. Examples of the polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene and polycarbonate. Particularly, from the viewpoint of electrochemical stability, polyacrylonitrile, polyvinylidene fluoride, polyhexafluoropropylene or polyethylene oxide is preferred.

The electrolyte layer 36 may contain inorganic grains. This is because the heat resistance can be further improved. As the inorganic grains, the inorganic grains same as those contained in the surface layer of the separator 23 of the second embodiment can be used. Further, instead of the electrolyte layer 36, an electrolytic solution may be used.

Next, an example of a method of manufacturing battery according to the third embodiment of the present technology will be described.

First, a precursor solution containing a solvent, an electrolyte salt, a polymer compound, and a mixed solvent is applied to each of the positive electrode 33 and the negative electrode 34, and the mixed solvent is volatilized to form the electrolyte layer 36. Next, the positive electrode lead 31 is attached to the end of the positive electrode current collector 33A by welding, and the negative electrode lead 32 is attached to the end of the negative electrode current collector 34A by welding. Next, the positive electrode 33 and the negative electrode 34 on which the electrolyte layer 36 is formed are laminated with the separator 35 interposed therebetween to form a laminated body, and then the laminated body is wound in the longitudinal direction, and the protective tape 37 is adhered to the outermost periphery to form the wound type electrode body 30. Finally, for example, the wound type electrode body 30 is sandwiched by the exterior member 40, and the outer edge portions of the exterior members 40 are made close contact and sealed by thermal fusion or the like. At this time, the adhesive films 41 are inserted between the exterior member 40 and the positive electrode lead 31, and the exterior member 40 and the negative electrode lead 32. Thereby, the battery shown in FIGS. 5 and 6 is obtained.

Further, this battery may be manufactured as follows. First, the positive electrode 33 and the negative electrode 34 are prepared as described above, and the positive electrode lead 31 and the negative electrode lead 32 are attached to the positive electrode 33 and the negative electrode 34, respectively. Next, the positive electrode 33 and the negative electrode 34 are laminated and wound with the separator 35 interposed therebetween, and the protective tape 37 is adhered to the outermost periphery to form a wound body. Next, the wound body is sandwiched by the exterior member 40, and the outer peripheral edge except for one side is thermally fused to have a bag shape and stored inside the exterior member 40. Next, an electrolyte composition including a solvent, an electrolyte salt, a monomer that is a raw material of the polymer compound, a polymerization initiator, and other materials such as a polymerization inhibitor as necessary is prepared, and is injected into the exterior members 40.

Next, after the electrolyte composition is injected into the exterior member 40, the opening of the exterior member 40 is thermally fused and sealed in a vacuum atmosphere. Next, the monomer is polymerized by heating so as to form a polymer compound, thereby forming the gelled electrolyte layer 36. Thus, the battery shown in FIGS. 5 and 6 is obtained.

In application example 1, a battery pack and an electronic device including the battery according to the second or third embodiment will be described.

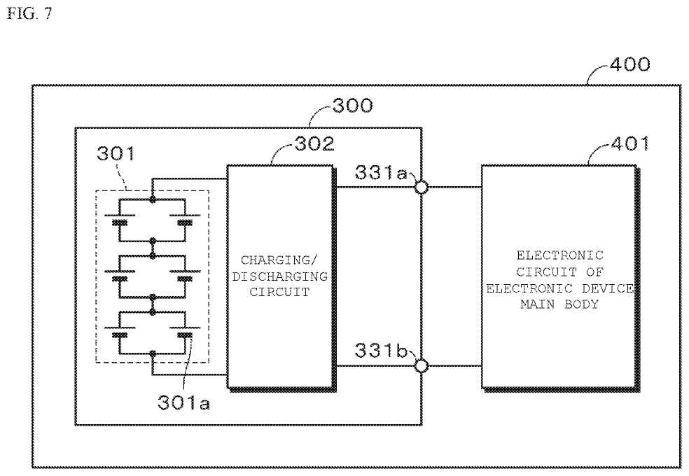

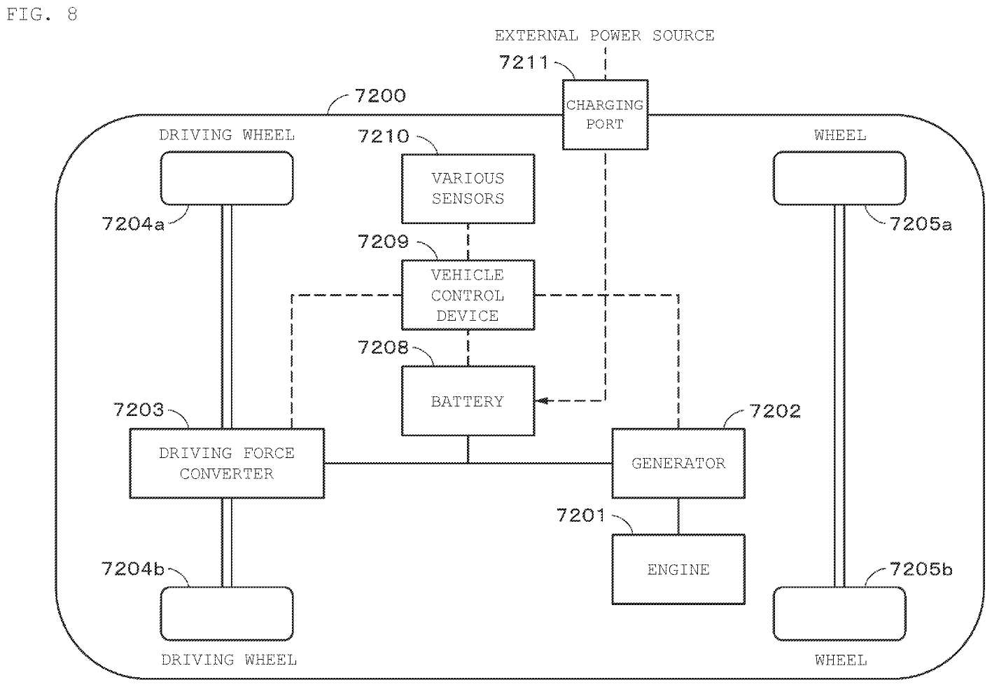

Hereinafter, a configuration example of a battery pack 300 and an electronic device 400 as application examples will be described with reference to FIG. 7. The electronic device 400 includes an electronic circuit 401 of the electronic device main body and the battery pack 300. The battery pack 300 is electrically connected to the electronic circuit 401 with a positive electrode terminal 331a and a negative electrode terminal 331b interposed therebetween. The electronic device 400 has a configuration in which the battery pack 300 can be detached by a user, for example. Note that the configuration of the electronic device 400 is not limited to this, and has a configuration in which the battery pack 300 is built in the electronic device 400 so that the user may not remove the battery pack 300 from the electronic device 400.

When the battery pack 300 is charged, the positive electrode terminal 331a and the negative electrode terminal 331b of the battery pack 300 are connected to the positive electrode terminal and the negative electrode terminal of a charger (not shown), respectively. On the other hand, when the battery pack 300 is discharged (when the electronic device 400 is used), the positive electrode terminal 331a and the negative electrode terminal 331b of the battery pack 300 are connected to the positive electrode terminal and the negative electrode terminal of the electronic circuit 401, respectively.

Examples of the electronic device 400 include, but not limited to, a notebook personal computer, a tablet computer, a mobile phone (such as a smartphone), a personal digital assistant (PDA), a display device (an LCD, an EL display, an electronic paper, etc.), an imaging device (for example, a digital still camera, a digital video camera, etc.), an audio device (for example, a portable audio player), a game device, a cordless phone, an electronic book, an electronic dictionary, a radio, a headphone, a navigation system, a memory card, a pacemaker, a hearing aid, an electric power tool, an electric shaver, a refrigerator, an air conditioner, a TV set, a stereo, a water heater, a microwave oven, a dishwasher, a washing machine, a dryer, a lighting device, a toy, a medical device, a robot, a road conditioner, a traffic light.

The electronic circuit 401 includes, for example, a CPU, a peripheral logic unit, an interface unit, a storage unit, and the like, and controls the entire electronic device 400.

The battery pack 300 includes an assembled battery 301 and a charging/discharging circuit 302. The assembled battery 301 is configured by connecting a plurality of secondary batteries 301a in series and/or in parallel. The plurality of secondary batteries 301a is connected to each other, for example, in n parallel and m series arrays (n and m are positive integers). FIG. 7 shows an example in which six secondary batteries 301a are connected to each other in two parallel and three series (2P3S) arrays. As the secondary battery 301a, the battery according to the second or third embodiment is used.

Here, the case where the battery pack 300 includes the assembled battery 301 including a plurality of secondary batteries 301a will be described. However, the battery pack 300 may include a single secondary battery 301a instead of the assembled battery 301.

The charging/discharging circuit 302 is a control unit that controls charging/discharging of the assembled battery 301. Specifically, during charging, the charging/discharging circuit 302 controls charging of the assembled battery 301. On the other hand, at the time of discharge (that is, when the electronic device 400 is used), the charging/discharging circuit 302 controls discharge to the electronic device 400.

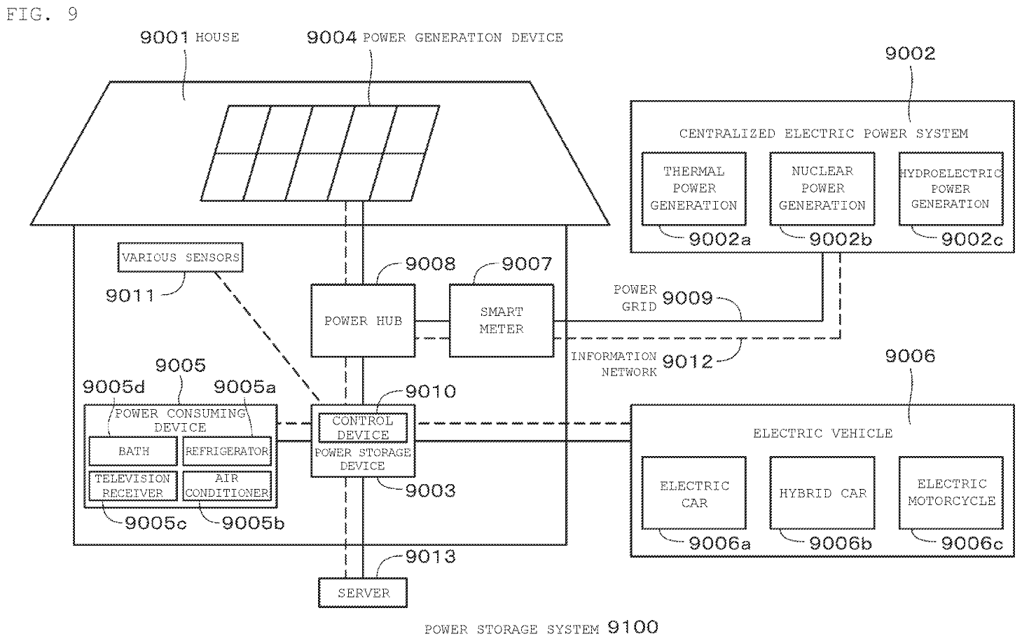

An example in which the present disclosure is applied to a power storage system for a vehicle will be described with reference to FIG. 8. FIG. 8 schematically shows an example of the configuration of a hybrid vehicle that employs a series hybrid system to which the present disclosure is applied. The series hybrid system is a car that travels by an electric power/driving force converter using power generated by a generator driven by an engine or power stored in a battery which stores temporarily the generated power.

A hybrid vehicle 7200 includes an engine 7201, a generator 7202, an electric power/driving force converter 7203, a driving wheel 7204a, a driving wheel 7204b, a wheel 7205a, a wheel 7205b, a battery 7208, a vehicle control device 7209 (controller), various sensors 7210, a charging port 7211. The electric power storage device of the present disclosure mentioned above is applied to the battery 7208. The vehicle control device 7209 (controller) includes a processor or the like.

The hybrid vehicle 7200 travels using the electric power/driving force converter 7203 as a power source. An example of the electric power/driving force converter 7203 is a motor. The electric power/driving force converter 7203 is operated by the power of the battery 7208, and the rotational force of the electric power/driving force converter 7203 is transmitted to the driving wheels 7204a and 7204b. Note that by using DC-AC (DC-AC) or reverse conversion (AC-DC conversion) where necessary, the electric power/driving force converter 7203 can be used as either an AC motor or a DC motor. The various sensors 7210 control the engine speed with the vehicle control device 7209 interposed therebetween and control the opening degree (throttle opening degree) of a throttle valve (not shown). The various sensors 7210 include a speed sensor, an acceleration sensor, an engine speed sensor, and the like.

The rotational force of the engine 7201 can be transmitted to the generator 7202, and the power generated by the generator 7202 by rotational force of the engine can be stored in the battery 7208.

When the hybrid vehicle is decelerated by a braking mechanism (not shown), a resistance at the time of deceleration is applied as a rotational force to the electric power/driving force converter 7203, and the regenerative electric power generated by the electric power/driving force converter 7203 by the rotational force is stored in the battery 7208.

The battery 7208 can be connected to a power source external to the hybrid vehicle to receive power from the external power source using the charging port 211 as an input port, and can store the received power.

Although not shown, an information processing apparatus that performs information processing related to vehicle control based on information related to the secondary battery may be provided. The information processing apparatus includes, for example, an information processing apparatus that performs the remaining battery level display based on information on a remaining battery level.

In the above, the series hybrid vehicle traveling by the motor using the power generated by the generator driven by the engine or the power stored in the battery which stores temporarily the generated power has been described as an example. However, the present disclosure is also effective for a parallel hybrid vehicle in which the engine and motor outputs are both drive sources, and three ways of travel by only the engine, travel by only the motor, and travel by both the engine and the motor are appropriately switched for use. Furthermore, the present disclosure can be effectively applied to a so-called electric vehicle that travels by only the driving motor without using an engine.

Heretofore, an example of the hybrid vehicle 7200 to which the technology according to the present disclosure can be applied has been described. The technology according to the present disclosure can be preferably applied to the battery 7208 among the configurations described above.

An example in which the present disclosure is applied to a residential power storage system will be described with reference to FIG. 9. For example, in a power storage system 9100 for a house 9001, power is supplied to an electric power storage device 9003 from a centralized electric power system 9002 such as a thermal power generation 9002a, a nuclear power generation 9002b, a hydroelectric power generation 9002c, etc. with a power grid 9009, an information network 9012, a smart meter 9007, a power hub 9008, etc. interposed therebetween. At the same time, power is supplied to the electric power storage device 9003 from an independent power source such as a home power generation device 9004. Power supplied to the electric power storage device 9003 is stored. The electric power storage device 9003 is used to supply power used in the house 9001. The same power storage system can be used not only for the house 9001 but also for the building.

The house 9001 is provided with a power generation device 9004, a power consuming device 9005, the electric power storage device 9003, a control device 9010 (controller) that controls each device, the smart meter 9007, and sensors 9011 for acquiring various information. The respective devices are connected by the power grid 9009 and the information network 9012. A solar cell, a fuel cell, or the like is used as the power generation device 9004, and the generated electric power is supplied to the power consuming device 9005 and/or the electric power storage device 9003. The power consuming device 9005 is, for example, a refrigerator 9005a, an air conditioner 9005b, a television receiver 9005c, and a bath 9005d. Furthermore, the power consuming device 9005 includes an electric vehicle 9006. The electric vehicle 9006 is an electric car 9006a, a hybrid car 9006b, and an electric motorcycle 9006c.

The above-described battery unit according to the present disclosure is applied to the electric power storage device 9003. The electric power storage device 9003 is composed of a secondary battery or a capacitor.

For example, it is composed of a lithium ion battery. The lithium ion battery may be a stationary type or may be used in the electric vehicle 9006. The smart meter 9007 has a function of measuring the usage amount of commercial power and transmitting the measured usage amount to the power company. The power grid 9009 may combine any one or more of direct current feeding, alternating current feeding, and non-contact feeding.

The various sensors 9011 are, for example, a human sensor, an illuminance sensor, an object detection sensor, a power consumption sensor, a vibration sensor, a contact sensor, a temperature sensor, an infrared sensor, and the like. The information acquired by the various sensors 9011 is transmitted to the control device 9010. With the information from the sensors 9011, the state of the weather, the state of a person, etc. can be grasped, and the power consuming device 9005 can be automatically controlled to minimize energy consumption. Furthermore, the control device 9010 can transmit information on the house 9001 to an external power company or the like with the Internet interposed therebetween.

The power hub 9008 performs processing such as branching of power lines and DC/AC conversion. Examples of the communication method of the information network 9012 connected to the control device 9010 include a method using a communication interface such as a universal asynchronous receiver-transmitter (UART), and a method of using a sensor network according to a wireless communication standard such as Bluetooth (registered trademark), ZigBee (registered trademark), and Wi-Fi. The Bluetooth (registered trademark) system is applied to multimedia communication, and can perform one-to-many connection communication. ZigBee (registered trademark) uses a physical layer of Institute of Electrical and Electronics Engineers (IEEE) 802.15.4. IEEE 802.15.4 is the name of a short-range wireless network standard called a personal area network (PAN) or a wireless (W) PAN.

The control device 9010 is connected to an external server 9013. The server 9013 may be managed by any one of the house 9001, a power company, and a service provider. The information transmitted and received by the server 9013 is, for example, power consumption information, life pattern information, power rates, weather information, natural disaster information, and information on power transactions. These pieces of information may be transmitted and received from a home power consuming device (for example, a television receiver), or may be transmitted and received from a device outside the home (for example, a cellular phone or the like). These pieces of information may be displayed on a device having a display function, for example, a television receiver, a cellular phone, a personal digital assistant (PDA) or the like.

The control device 9010 that controls each unit is composed of a central processing unit (CPU) or a processor, a random access memory (RAM), a read only memory (ROM), and the like, and is stored in the electric power storage device 9003 in this example. The control device 9010 is connected to the electric power storage device 9003, the home power generation device 9004, the power consuming device 9005, the various sensors 9011, the server 9013 via the information network 9012, and has a function to adjust, for example, the usage amount of commercial power and the power generation amount. In addition, it may have the function of performing a deal of power exchange in an electric power market.

As described above, not only the power from the centralized electric power system 9002 such as the thermal power generation 9002a, the nuclear power generation 9002b, the hydroelectric power generation 9002c, etc., but also the power generated by the home power generation device 9004 (solar power, wind power) can be stored in the electric power storage device 9003. Therefore, even when the power generated by the home power generation device 9004 fluctuates, control can be performed such that the amount of power to be transmitted to the outside can be made constant, or the necessary amount of discharge can be performed. For example, the control may be performed such that the power obtained by the solar power generation is stored in the electric power storage device 9003, and late-night power with low charge is stored in the electric power storage device 9003 at night, and the power stored by electric power storage device 9003 is discharged in a time zone where the charge in the daytime is high.

Although the example in which control device 9010 is stored in electric power storage device 9003 has been described, it may be stored in smart meter 9007 or may be configured alone. Furthermore, the power storage system 9100 may be used for a plurality of households in an apartment house, or may be used for a plurality of detached houses.

Heretofore, an example of the power storage system 9100 to which the technology according to the present disclosure can be applied has been described. The technology according to the present disclosure can be preferably applied to the secondary battery included in the electric power storage device 9003 among the configurations described above.

Hereinafter, the present technology will be specifically described by way of Examples, but the present technology is not limited to only these examples.

In Examples, the average number of grain boundaries per positive electrode active substance grain is a value calculated by the “calculation method of the average number of grain boundaries per positive electrode active substance grain” in the first embodiment.

### Examples 1-1 to 1-4, Comparative Examples 1-1 to 1-3

A positive electrode active substance was produced as follows. First, Co₃O₄ was produced by roasting cobalt hydroxide by a raw material. Next, a powder of Li₂CO₃ as a lithium compound and a powder of Co₃O₄ as a transition metal compound were mixed, dried and fired to produce the lithium cobalt oxide (LiCoO₂), and the lithium cobalt oxide was particle sized to produce a positive electrode active substance.

In the above-described positive electrode active substance manufacturing process, the following methods (1) to (3) were performed to obtain a positive electrode active substance with a reduced number of grain boundaries.

### (1) Method of Suppressing Crystal Nuclei Caused by Impurities

Crystal nuclei caused by impurities were suppressed by setting the nonmetallic ions contained in the raw material to 100 ppm or less and the metallic ions to 40 ppm. Here, a case where an additive element is not added to LiCoO₂ will be described. However, an additive element may be added to LiCoO₂, and in this case, the additive element is excluded from impurities.

(2) Method of Suppressing Grain Boundary Generation Due to Phase Transition of Co₃O₄ Raw Material

Co₃O₄ undergoes phase transition to CoO at a temperature of about 900° C., and this phase transition may induce grain boundaries. Thus, when Co3O4 was produced by roasting cobalt hydroxide as a raw material, the production temperature was set to 800° C. or lower.

By the same reason, in the production of LiCoO₂, after mixing Li₂CO₃ and Co₃O₄, the mixture was calcined in the low temperature range of 350° C. to 600° C., and the final heat treatment was performed at 850° C. or lower.

### (3) Method of Suppressing Generation of Grain Boundaries Due to Pulverization and Heat Treatment

When the LiCoO₂ is pulverized, defects are generated, and grain boundaries may be formed in the process of recovering the defects by heat treatment after pulverization. In order to suppress the generation of grain boundaries during the recovery process, pulverization was not performed and particle sized LiCoO₂ was used as the positive electrode active substance.

Here, the case where the above methods (1) to (3) are combined will be described. However, one of the above methods (1) to (3) may be used alone, or two may be combined. However, in order to further reduce the number of grain boundaries in the positive electrode active substance grains, it is preferable to combine all three of the above methods (1) to (3).

Next, a positive electrode active substance (lithium cobalt oxide) with a reduced number of grain boundaries and a commercially available positive electrode active substance (lithium cobalt oxide) were mixed to obtain a mixed powder. At this time, by adjusting the mixing ratio (weight ratio) between the positive electrode active substance with a reduced number of grain boundaries and a commercially available positive electrode active substance, the average number of grain boundaries per positive electrode active substance grain in the mixed powder was changed within the range of 0.22 or more to 2.25 or less.

Using the mixed powder (positive electrode active substance) obtained as described above, a positive electrode was produced as follows. First, a positive electrode active substance (surface-coated LiCoO₂ grain powder), a conductive agent (carbon black), and a binder (polyvinylidene fluoride) were mixed so as to have a weight ratio of positive electrode active substance:conductive material:binder=90:5:5 to obtain the positive electrode mixture. Next, an appropriate amount of N-methyl-2-pyrrolidone (NMP) was added to this positive electrode mixture and kneaded to obtain a positive electrode mixture slurry, and then this positive electrode mixture slurry was applied onto the positive electrode current collector (Al foil), and dried to form a positive electrode active substance layer. Finally, the positive electrode active substance layer was compression molded using a press to obtain a positive electrode.

The negative electrode was produced as follows. First, a negative electrode active substance (graphite material) and a binder (polyvinylidene fluoride) were mixed so as to have a weight ratio of negative electrode active substance:binder=95:5 to obtain a negative electrode mixture. Next, an appropriate amount of N-methyl-2-pyrrolidone (NMP) was added to the negative electrode mixture and kneaded to form a negative electrode mixture slurry, and then the negative electrode mixture slurry was applied onto the negative electrode current collector (Cu foil), and dried to form a negative electrode active substance layer. Finally, the negative electrode active substance layer was compression molded using a press to obtain a negative electrode.

A non-aqueous electrolytic solution was prepared as follows. First, ethylene carbonate (EC) and dimethyl carbonate (DMC) were mixed at a mass ratio of EC:DMC=1:1 to prepare a mixed solvent. Next, a non-aqueous electrolytic solution was prepared by dissolving lithium hexafluorophosphate (LiPF₆) as an electrolyte salt in this mixed solvent at a concentration of 1 mol/kg.

A laminated film type battery was produced as follows. First, the positive electrode lead and the negative electrode lead were welded to the positive electrode and the negative electrode obtained as described above, respectively, and then the positive electrode and the negative electrode were alternately laminated with a separator made of a polyethylene microporous film interposed therebetween to obtain an electrode body.

Next, this electrode body was loaded between exterior members, and three sides of the exterior member were thermally fused, and one side was not thermally fused, but had an opening. As the exterior member, a moisture-proof aluminum laminated film in which a 25 μm-thick nylon film, a 40 μm-thick aluminum foil, and a 30 μm-thick polypropylene film were laminated in order from the outermost layer was used. Thereafter, a non-aqueous electrolytic solution solution was injected from the opening of the exterior member, and the remaining one side of the exterior member was thermally fused under reduced pressure to seal the electrode body. Thereby, the target laminated film type battery was obtained. The laminated film type battery was designed so that the amount of the positive electrode active substance and the amount of the negative electrode active substance were adjusted, and the open circuit voltage (that is, the battery voltage) at the time of full charge was 4.25 V

### Examples 2-1 to 2-4, Comparative Examples 2-1 to 2-3

The laminated film type battery was obtained in the same manner as in Examples 1-1 to 1-4 and Comparative Examples 1-1 to 1-3, except that the laminated film type battery was designed so that the amount of the positive electrode active substance and the amount of the negative electrode active substance were adjusted, and the open circuit voltage (that is, the battery voltage) at the time of full charge was 4.30 V.

### Examples 3-1 to 3-4, Comparative Examples 3-1 to 3-3

The laminated film type battery was obtained in the same manner as in Examples 1-1 to 1-4 and Comparative Examples 1-1 to 1-3, except that the laminated film type battery was designed so that the amount of the positive electrode active substance and the amount of the negative electrode active substance were adjusted, and the open circuit voltage (that is, the battery voltage) at the time of full charge was 4.35 V.

### Examples 4-1 to 4-4, Comparative Examples 4-1 to 4-3

The laminated film type battery was obtained in the same manner as in Examples 1-1 to 1-4 and Comparative Examples 1-1 to 1-3, except that the laminated film type battery was designed so that the amount of the positive electrode active substance and the amount of the negative electrode active substance were adjusted, and the open circuit voltage (that is, the battery voltage) at the time of full charge was 4.40 V.

### Examples 5-1 to 5-4, Comparative Examples 5-1 to 5-3

The laminated film type battery was obtained in the same manner as in Examples 1-1 to 1-4 and Comparative Examples 1-1 to 1-3, except that the laminated film type battery was designed so that the amount of the positive electrode active substance and the amount of the negative electrode active substance were adjusted, and the open circuit voltage (that is, the battery voltage) at the time of full charge was 4.45 V.

### Examples 6-1 to 6-4, Comparative Examples 6-1 to 6-3

The laminated film type battery was obtained in the same manner as in Examples 1-1 to 1-4 and Comparative Examples 1-1 to 1-3, except that the laminated film type battery was designed so that the amount of the positive electrode active substance and the amount of the negative electrode active substance were adjusted, and the open circuit voltage (that is, the battery voltage) at the time of full charge was 4.50 V.

The discharge capacitance retention rate of the battery obtained as described above was determined as follows. First, 100 cycles of charge/discharge operations were performed at 25° C., and the “initial discharge capacitance” and the “discharge capacitance at the 100th cycle” were obtained. The following charge/discharge operation was defined as one cycle. That is, following the constant current and constant voltage charging operation in which the charging current was 20 mA per 1 g of the positive electrode active substance, and the charging voltage was 4.25 V (Examples 1-1 to 1-4, Comparative Examples 1-1 to 1-3), 4.30 V (Examples 2-1 to 2-4, Comparative Examples 2-1 to 2-3), 4.35 V (Examples 3-1 to 3-4, Comparative examples 3-1 to 3-3), 4.40 V (Examples 4-1 to 4-4, Comparative examples 4-1 to 4-3), 4.45 V (Examples 5-1 to 5-4, Comparative Examples 5-1 to 5-3), or 4.50 V (Examples 6-1 to 6-4, Comparative Examples 6-1 to 6-3), the process of performing the constant current discharge operation in which the discharge current was 20 mA per 1 g of the positive electrode active substance, and the discharge voltage was 3 V was defined as one cycle. Next, using the “initial discharge capacitance” and the “discharge capacitance at the 100th cycle”, the discharge capacitance retention rate (%) (=((discharge capacitance at the 100th cycle)/(initial discharge capacitance))×100) was obtained.

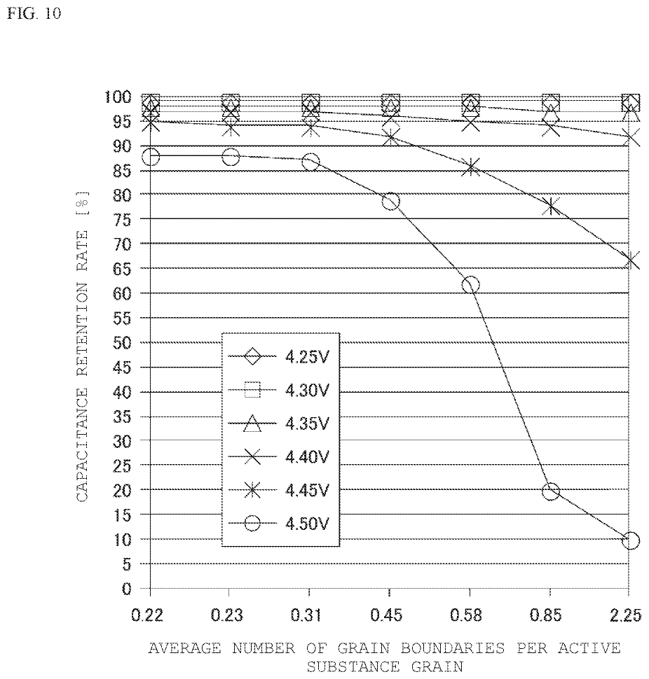

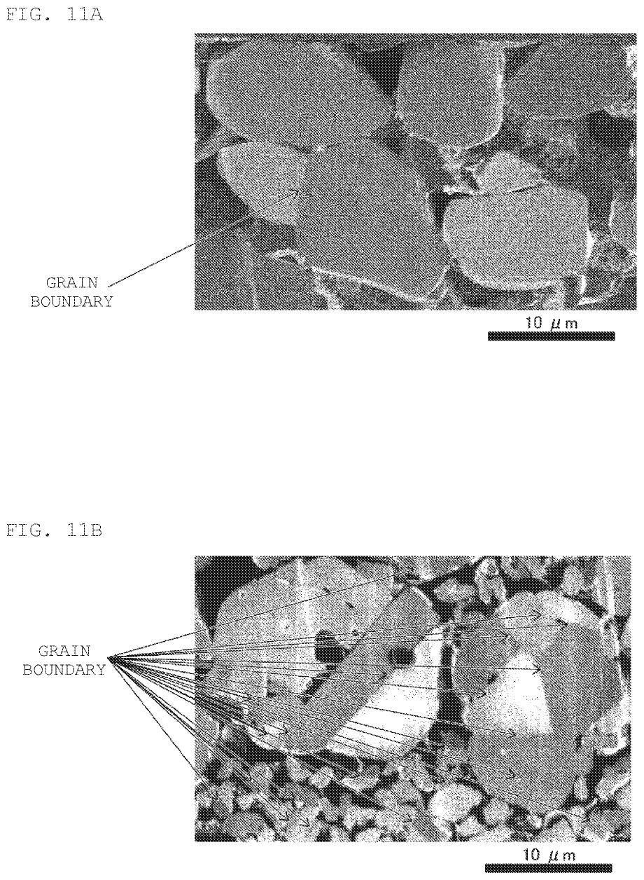

FIG. 10 is a graph showing the relationship between the average number of grain boundaries per positive electrode active substance grain and the cycle characteristics. The following can be seen from FIG. 10. In a battery including a positive electrode active substance whose average number of grain boundaries per positive electrode active substance grain is 0.58 or more, cycle characteristics are deteriorated. In particular, the cycle characteristics are significantly deteriorated in a battery having a high potential voltage exceeding 4.40 V. On the other hand, in a battery including a positive electrode active substance whose average number of grain boundaries per positive electrode active substance grain is less than 0.58, good cycle characteristics can be obtained. In particular, in a battery including a positive electrode active substance whose average number of grain boundaries per positive electrode active substance grain is 0.45 or less, cycle characteristics are good.

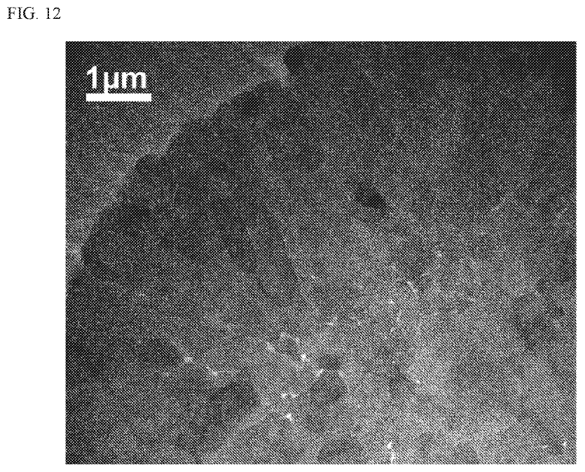

FIG. 11A shows a SIM image of a cross section of LiCoO₂ grain powder whose average number of grain boundaries is 0.23 per LiCoO₂ grain. FIG. 11B is a SIM image of a cross-section of LiCoO₂ grain powder whose average number of grain boundaries per LiCoO₂ grain is 2.25. FIG. 12 is a TEM image of a cross section of the NCA-based positive electrode active substance grains.

As shown in FIG. 12, the NCA-based positive electrode active substance may have a secondary grain form composed of primary grains of about several hundred nm to several m. In such a form, since the primary grain interface in the secondary grains corresponds to the grain boundary of the LiCoO₂-based positive electrode active substance, the average number of grain boundaries is generally larger than that of the LiCoO₂-based active substance (see FIGS. 11A, 11B, and 12). Therefore, it can be said that the present technology is particularly effective when applied to a LiCoO₂-based positive electrode active substance among positive electrode active substances having a layered rock salt type structure.

As described above, the embodiments of the present technology and the modifications thereof, and Examples have been specifically described, but the present technology is not limited to the above-described embodiments and its modified examples and Examples. Various modifications based on the technical idea of the present technology are possible.

For example, the configurations, methods, steps, shapes, materials, numerical values, and the like given in the above-described embodiments and its modifications, and Examples are merely examples, and different configurations, methods, steps, and shapes, materials, numerical values, and the like may be used as necessary. In addition, chemical formulas of compounds and the like are representative ones, and are not limited to the indicated valences and the like as long as they are common names of the same compounds.

In addition, the configurations, methods, steps, shapes, materials, numerical values, and the like given in the above-described embodiments and its modifications, and Examples can be combined with each other without departing from the gist of the present technology.

In the above-described embodiments and Examples, the examples in which the present technology is applied to cylindrical and laminated film secondary batteries have been described. However, the shape of the battery is not particularly limited thereto. For example, the present technology can be applied to secondary batteries such as prismatic and coin-type batteries, and the present technology can be applied to flexible batteries mounted on wearable terminals such as a smart watch, a head mounted display, and an iGlass (registered trademark).

In the above-described embodiments and Examples, the examples in which the present technology is applied to the wound type and stack type secondary batteries has been described, but the structure of the battery is not limited thereto. For example, the present technology can be applied to a secondary battery having a structure in which a positive electrode and a negative electrode are folded.

Moreover, in the above-described embodiments and Examples, the examples in which the present technology is applied to the lithium ion secondary battery and the lithium ion polymer secondary battery, but the kind of battery to which the present technology is applicable is not limited thereto. For example, the present technology may be applied to an all solid state battery such as an all solid state lithium ion secondary battery.

The all solid state battery to which the present technology is applied includes, for example, a positive electrode having a positive electrode current collector and a positive electrode active substance layer, a negative electrode having a negative electrode current collector and a negative electrode active substance layer, a solid electrolyte layer, and an exterior member that houses the positive electrode, the negative electrode, and the solid electrolyte. The positive electrode active substance layer includes the positive electrode active substance according to the first embodiment and the solid electrolyte. The negative electrode active substance layer includes the negative electrode active substance and the solid electrolyte.

In the all solid state battery having the above configuration, since the positive electrode includes the positive electrode active substance according to the first embodiment, good cycle characteristics can be obtained.

The all solid state battery having the above configuration is manufactured, for example, as follows. First, a positive electrode is produced by forming a positive electrode active substance layer including a positive electrode active substance and a solid electrolyte on a positive electrode current collector. Next, a negative electrode is produced by forming a negative electrode active substance layer including a negative electrode active substance and a solid electrolyte on the negative electrode current collector. Subsequently, the solid electrolyte is sandwiched by the positive electrode and the negative electrode, and fired to form a laminated body, and then the laminated body is sandwiched by the exterior members, and the peripheral edge of the exterior member is thermally fused. Thereby, the target all solid state battery is obtained.

Moreover, in the above-described embodiments and Examples, the configuration in which the electrode includes a current collector and an active substance layer has been described as an example, but the structure of the electrode is not limited to thereto. For example, the electrode may be composed of only the active substance layer.

In addition, the present technology is described below in further detail according to an embodiment of the present disclosure.

(1) A battery including a positive electrode, a negative electrode, and an electrolyte, wherein

the positive electrode includes a powder of positive electrode active substance grains, and

an average number of grain boundaries per one of the positive electrode active substance grains is less than 0.58.

(2) The battery according to (1), wherein the positive electrode active substance grains include a lithium transition metal composite oxide having a layered rock salt type structure.

(3) The battery according to (2), wherein the lithium transition metal composite oxide includes at least one of a lithium cobalt oxide and a composite obtained by substituting part of cobalt of a lithium cobalt oxide with another metal element.

(4) The battery according to (2), wherein

the lithium transition metal composite oxide has an average composition represented by Equation (1)

LiᵣCo₍₁₋ₛ₎MₛO₍₂₋ₜ₎Fᵤ (1)

where in Equation (1), M represents at least one selected from the group consisting of nickel, manganese, magnesium, aluminum, boron, titanium, vanadium, chromium, iron, copper, zinc, molybdenum, tin, calcium, strontium, and tungsten, and r, s, t, and u are values within a range of 0.8≤r≤1.2, 0≤s<0.5, −0.1≤t≤0.2, and 0≤u≤0.1, a composition of lithium differs depending on a state of charge and discharge, and a value of r represents a value in a completely discharged state.

(5) The battery according to (4), wherein M in Equation (1) is at least one of aluminum, magnesium, and titanium.

(6) The battery according to any one of (1) to (5), wherein the average number of grain boundaries per one of the positive electrode active substance grains is 0.5 or less.

(7) The battery according to any one of (1) to (6), wherein a potential of the positive electrode in a fully charged state exceeds 4.20 V (vsLi/Li⁺).

(8) The battery according to any one of (1) to (7), wherein a potential of the positive electrode in a fully charged state exceeds 4.40 V (vsLi/Li⁺).

(9) A positive electrode active substance including a powder of positive electrode active substance grains, wherein

an average number of grain boundaries per one of the positive electrode active substance grains is less than 0.58.

(10) A positive electrode including a powder of positive electrode active substance grains, wherein

an average number of grain boundaries per one of the positive electrode active substance grains is less than 0.58.

(11) A battery pack including:

the battery according to any one of (1) to (8); and

a control unit that controls the battery.

(12) An electronic device including a battery according to any one of (1) to (8), wherein

the electronic device receives supply of electric power from the battery.

(13) An electric vehicle including:

a battery according to any one of (1) to (8);

a converter that receives supply of electric power from the battery and converts the received electric power into a driving force of a vehicle; and

a control device that performs an information process relating to vehicle control based on information on the battery.

(14) An electric power storage device including the battery according to any one of (1) to (8), wherein

the electric power storage device supplies electric power to an electronic device connected to the battery.

(15) An electric power system including the battery according to any one of (1) to (8), wherein

the electric power system receives supply of electric power from the battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising a positive electrode, a negative electrode, and an electrolyte, wherein the positive electrode includes a plurality of positive electrode active substance grains, and
an average number of grain boundaries per one of the positive electrode active substance grains is less than 0.58.

2. The battery according to claim 1, wherein the positive electrode active substance grains include a lithium transition metal composite oxide having a layered rock salt type structure.

3. The battery according to claim 2, wherein the lithium transition metal composite oxide includes at least one of a lithium cobalt oxide and a composite obtained by substituting cobalt of a lithium cobalt oxide with a metal element.

4. The battery according to claim 2, wherein
the lithium transition metal composite oxide include an average composition represented by Equation (1)
LiᵣCo₍₁₋ₛ₎MₛO₍₂₋ₜ₎Fᵤ (1)
wherein, M represents at least one selected from the group consisting of nickel, manganese, magnesium, aluminum, boron, titanium, vanadium, chromium, iron, copper, zinc, molybdenum, tin, calcium, strontium, tungsten and combinations thereof, and r, s, t, and u are values within a range of 0.8≤r≤1.2, 0≤s<0.5, −0.1≤t≤0.2, and 0≤u≤0.1, and a value of r represents a value in a completely discharged state.

5. The battery according to claim 4, wherein M in Equation (1) includes at least one of aluminum, magnesium, titanium and combinations thereof.

6. The battery according to claim 1, wherein the average number of grain boundaries per one of the positive electrode active substance grains is 0.5 or less.

7. The battery according to claim 1, wherein a potential of the positive electrode in a fully charged state exceeds 4.20 V (vsLi/Li⁺).

8. The battery according to claim 1, wherein a potential of the positive electrode in a fully charged state exceeds 4.40 V (vsLi/Li⁺).

9. A positive electrode active substance comprising a plurality of positive electrode active substance grains, wherein
an average number of grain boundaries per one of the positive electrode active substance grains is less than 0.58.

10. A positive electrode comprising a plurality of positive electrode active substance grains, wherein
an average number of grain boundaries per one of the positive electrode active substance grains is less than 0.58.

11. A battery pack comprising:
the battery according to claim 1; and
a controller configured to control the battery.

12. An electronic device comprising the battery according to claim 1, wherein the electronic device is configured to receive supply of electric power from the battery.

13. An electric vehicle comprising:
the battery according to claim 1;
a converter configured to receive supply of electric power from the battery and convert the received electric power into a driving force of a vehicle; and
a controller configured to perform an information process relating to vehicle control based on information on the battery.

14. An electric power storage device comprising the battery according to claim 1, wherein
the electric power storage device is configured to supply electric power to an electronic device connected to the battery.

15. An electric power system comprising the battery according to claim 1, wherein
the electric power system is configured to receive supply of electric power from the battery.
